(19) United States
(12) Patent Application Publication
(10) Pub. No.: US 2005/0251587 A1
(43) Pub. Date: Nov. 10, 2005

(54) Expandable optical disk recording and playing system and main board thereof

(75) Inventors: Li-Cheng Lin, Shindian City (TW); Benjamin Pan, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/998,611

(22) Filed: Nov. 30, 2004

Related U.S. Application Data
(60) Provisional application No. 60/568,668, filed on May 7, 2004.

(51) Int. Cl. G06F 13/10

(52) U.S. Cl. 710/2

(57) ABSTRACT

An expandable optical disk recording and playing system and main board thereof including an input interface module; a PCI expanding interface module, which includes a PCI bus and an expanding component for connecting to a expanding interface, the expanding interface connecting to an expandable external device; a storage interface module, which is used to connect to a storage device; an output interface module; and a CODEC module, which encodes, decodes or transcodes an audio/video source to generate audio/video data, wherein the audio/video source is inputted from the input interface module, the PCI expanding interface module, or the storage interface module, and the audio/video data is outputted through the output interface module, through the PCI expanding interface module to the external device, or through the storage interface module to the storage device.

### CROSS REFERENCE TO RELATED APPLICATIONS

The applicants claim the benefit of the filing data of provisional application No. 60/568,668 filed May 7, 2004, under 35 USC §119(e) (1).

### DETAILED DESCRIPTION OF THE INVENTION

### BACKGROUND OF THE INVENTION

1. Field of Invention

The invention relates to an optical disk recording and playing system and main board thereof and, in particular, to an expandable optical disk recording and playing system and main board, which can expand external devices via PCI bus.

2. Related Art

In general, the conventional optical disk recording and playing system usually receives an A/V (audio/video) source, then encodes/decodes the received A/V source, and finally outputs the encoded/decoded A/V source. The A/V source can be outputted by the way of directly recording to a storage device such as a hard disk drive or an optical disk, or by the way of playing through, such as, a monitor and a speaker for outputting images and voices.

With reference to FIG. 1, a conventional optical disk recording and playing system 1, such as a DVD ROM/recorder, includes an input interface 11, a CODEC module 12, a microprocessor 13, a memory module 14, a storage interface module 15, and an output interface 16. The input interface 11 is for receiving an A/V source 20. The microprocessor 13 and memory module 14 cooperate with the CODEC module 12 to encode, decode or transcode the A/V source 20 for generating A/V data. The storage interface module 15 connects to a storage device 31 such as a hard disk drive or a DVD recorder. When the storage device is a DVD recorder, the storage interface module 15 is a conventional ATA interface. The output interface 16 outputs the encoded, decoded or transcoded A/V data, and may further connect to an output device 32 such as a monitor and a speaker. Thus, the monitor can display the outputted image, and the speaker can output the voice. In addition, the conventional optical disk recording and playing system further includes a first peripheral interface 17 and a second peripheral interface 18, which are used to connect with a first external device 33 and a second external device 34, respectively. In this case, to build the connections between the optical disk recording and playing system 1 and the first external device 33 and second external device 34 in necessary, the optical disk recording and playing system 1 must be installed the first peripheral interface 17 and second peripheral interface 18 in advance.

In the conventional optical disk recording and playing system 1, the first peripheral interface 17 and/or the second peripheral interface 18 are previously installed. In details, the manufacturer predicts the possible connection methods between the optical disk recording and playing system 1 and the external devices in future, and then designs the optical disk recording and playing system 1 with the required interface. For example, if the manufacturer predicts that the future connection method utilizes USB interfaces, the first peripheral interface 17 is an USB interface. If the manufacturer predicts that the future connection method utilizes IEEE 1394 standards, the second peripheral interface 18 is an IEEE 1394 interface. However, the above-mentioned predicting method may not suitable for the growing technology. For instance, the presently usable interface includes the network transmission interface such as the connecting port with RJ-45 connector, the infrared ray transmission interface, the Bluetooth transmission interface, and the likes. Of course, there are other novel transmission interfaces invented in the future. Thus, the previously installed first and second peripheral interfaces 17 and 18 are useless, resulting in inconvenient of users. In addition, if the predicted peripheral interfaces are not the required interfaces for users, the pre-installed peripheral interfaces become redundant appurtenances. As a result, even if the optical disk recording and playing system 1 is equipped with the unnecessary peripheral interfaces, the user has to purchase the entire optical disk recording and playing system 1 including the unnecessary peripheral interfaces.

### SUMMARY OF THE INVENTION

In view of the foregoing, the invention is to provide an expandable optical disk recording and playing system and a main board thereof, which can provide an expanding interface module for expanding external devices depending on actual demands.

To achieve the above, an expandable optical disk recording and playing system of the invention includes an input interface module, a PCI expanding interface module, a storage interface module, an output interface module and a CODEC module. In the invention, the PCI expanding interface module comprises a PCI bus and a slot for connecting to an expanding interface, which connects to an expandable external device. The storage interface module is used to connect to a storage device. The CODEC module encodes, decodes or transcodes an audio/video source to generate audio/video data. The audio/video data are outputted through the output interface module, through the PCI expanding interface module to the external device, and/or through the storage interface module to the storage device.

The invention further discloses a main board of an expandable optical disk recording and playing system, which comprises a PCI bus, at least one slot, and a processing chip. The slot connects to one end of the PCI bus and is for connecting to an expanding interface, which connects to an expandable external device. The PCI bus is for connecting the slot and internal devices of the expandable optical disk recording and playing system. The processing chip comprises an input interface module, a storage interface module, an output interface module, and a CODEC module. The CODEC module encodes, decodes or transcodes an audio/video source to generate audio/video data. The audio/video source is inputted from the input interface module, from the PCI bus and the slot, and/or from the storage interface module. The audio/video data are outputted through the output interface module, through the expanding interface to the external device, and/or through the storage interface module to a storage device.

As mentioned above, since the PCI interface is used to expanding external devices in the invention, the expandable optical disk recording and playing system and main board thereof can provide an expanding interface module for expanding external devices depending on actual demands. Therefore, when manufacturing the optical disk recording and playing system, it is unnecessary to preinstall the peripheral interface. Besides, users can expand the required peripheral interface depending on actual demands. As a result, the cost for the redundant peripheral interfaces can be saved. Furthermore, it is very convenient for the user to properly expand any required peripheral interface.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing a conventional optical disk recording and playing system;

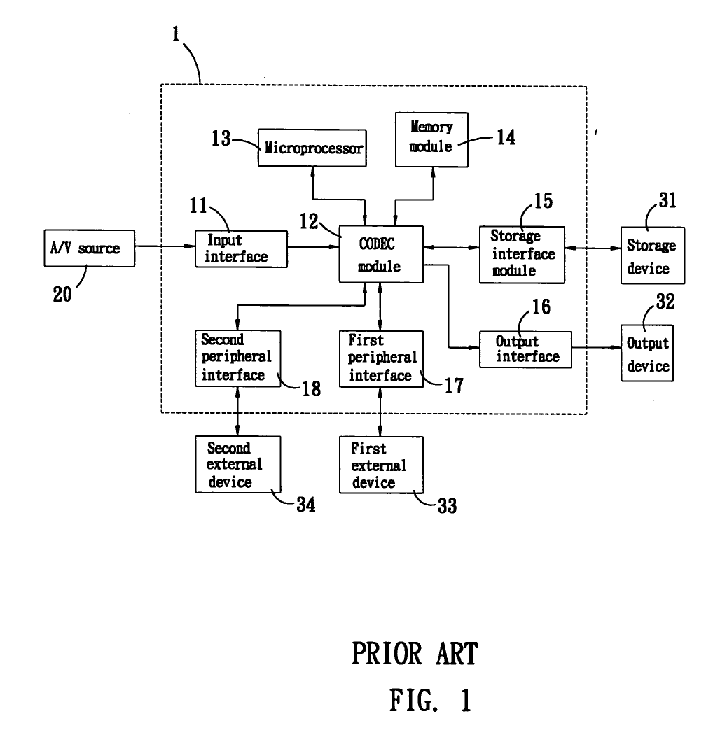

FIG. 2 is a schematic view showing an optical disk recording and playing system according to a preferred embodiment of the invention; and

FIG. 3 is a schematic view showing a main board of an optical disk recording and playing system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

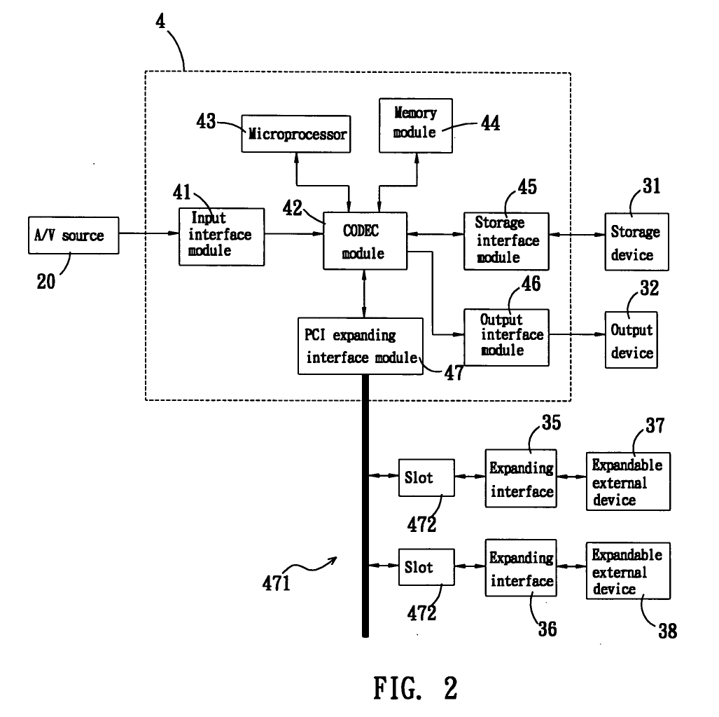

With reference to FIG. 2, an expandable optical disk recording and playing system 4 according to a preferred embodiment of the invention includes an input interface module 41, a CODEC module 42, a microprocessor 43, a memory module 44, a storage interface module 45, an output interface module 46, and a PCI expanding interface module.

In this embodiment, the input interface module 41 is for receiving an A/V source 20. The A/V source 20 can be analog A/V signals inputted from an antenna or a video cassette recorder (VCR). Otherwise, the A/V source 20 can be a digital A/V bitstream inputted from, for example, an optical disk, a PC or a network attached storage (NAS). The PCI expanding interface module 47 includes a PCI bus 471 and at least one slot 472. In the present embodiment, the PCI expanding interface module 47 includes two slots 472, which connect to expanding interfaces 35 and 36 respectively. To be noted, the slots of the invention can be substituted with any usable expanding component, which is familiar to one of ordinary skill in the art. The expanding interfaces 35 and 36 further respectively connect to expandable external devices 37 and 38. For instance, the expanding interfaces can be USB interfaces, IEEE 1394 interfaces, network interfaces, and the likes, and the expandable external devices can be memory cards, digital cameras, handy drivers, digital videos, or network attached storages (NAS). The storage interface module 45 is used to connect to a storage device 31, such as a hard disk driver or an optical disk driver. For example, if the storage device 31 is an optical disk driver, such as a DVD ROM, the storage interface module 45 is correspondingly an ATA interface. If the storage device 31 is an optical disk, the storage interface module 45 may further include a recording device (not shown) for recording the output(s) of the CODEC module 42 into this optical disk. The output interface module 46 is connected with an output device 32 such as a monitor and a speaker. Thus, the monitor can display the outputted image, and the speaker can output the voice.

As mentioned above, the CODEC module 42 is respectively connected with the input interface module 41, microprocessor 43, memory module 44, storage interface module 45, output interface module 46 and PCI expanding interface module 47. In the current embodiment, the previously mentioned modules can connect to one another with a system bus. In this case, the CODEC module 42 encodes, decodes or transcodes the A/V source 20 to generate A/V data. During the encoding, decoding or transcoding process, the CODEC module 42 may cooperate with the microprocessor 43 and memory module 44, such as the firmware or software codes stored in the memory module 44 and the calculating functions of the microprocessor 43. Accordingly, the A/V source 20 can be encoded, decoded or transcoded so as to generate the required A/V data.

To be noted, except inputted from the input interface module 41, the A/V source 20 can be inputted from the expandable external devices 37 and 38 through the PCI expanding interface module 47, or from the storage device 31 through the storage interface module 45. In addition, except outputted through the output interface module 46, the generated A/V data can be outputted to the expandable external devices 37 and 38 via the PCI expanding interface module 47, or to the storage device 31 via the storage interface module 45.

For example, when the digital A/V bitstream is inputted from the expandable external device 37 or 38, such as an NAS, through the PCI expanding interface module 47, the CODEC module 42 cooperates with the microprocessor 43 and memory module 44 to decode the digital A/V bitstream. The decoded A/V bitstream is then transmitted through the output interface module 46 to the output device 32, such as a monitor and a speaker for playing the decoded A/V bitstream. Alternatively, when the analog A/V signals are inputted through the antenna and the input interface module 41, the CODEC module 42 cooperates with the microprocessor 43 and memory module 44 to encode the analog A/V signals. Through the PCI expanding interface module 47, the encoded data are then transmitted to and stored in the expandable external devices 37 and 38, such as a handy driver. In addition, when the digital A/V bitstream is inputted from the storage device 31, such as a DVD ROM, the CODEC module 42 cooperates with the microprocessor 43 and memory module 44 to transcode the digital A/V bitstream. For example, the format of the digital A/V bitstream can be transcoded from WAV format to MP3 format. After that, the transcoded data are outputted through the PCI expanding interface module 47 and are then stored in the expandable external device 37 or 38, such as a handy driver.

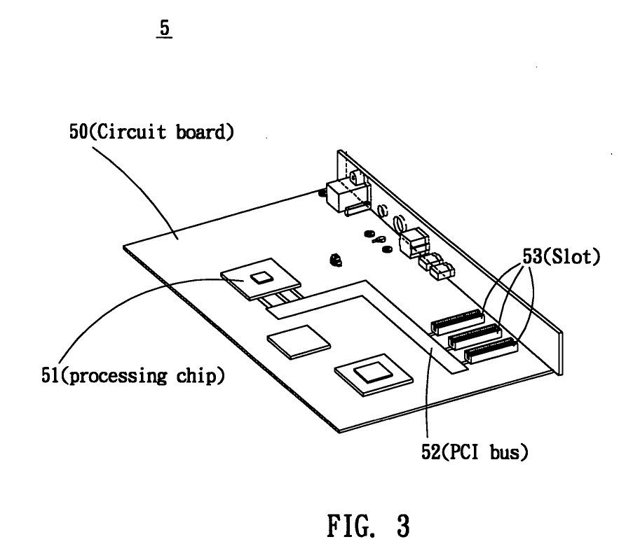

With reference to FIG. 3, a main board 5 of an expandable optical disk recording and playing system includes a processing chip 51, a PCI bus 52, and at least one slot 53. In the present embodiment, the processing chip 51 includes an input interface module, a storage interface module, an output interface module, and a CODEC module. The processing chip 51, PCI bus 52, and slot 53 are all embedded in a circuit board 50.

As mentioned above, the functions of the input interface module, storage interface module, output interface module and CODEC module are the same as the previous-mentioned input interface module 41, storage interface module 45, output interface module 46 and CODEC module 42, so the detailed descriptions are omitted for concise purpose. Furthermore, the processing chip 51 may include the disclosed microprocessor 43 and memory module 44. Herein, the microprocessor 43 can be an individual chip or chipset separated from the processing chip 51, and the memory module 44 can be an individual DRAM, SRAM or flash memory separated from the processing chip 51.

As shown in FIG. 3, the slots 53 are connected to one end of the PCI bus 52 and are respectively for connecting with an expanding interface, which is for connecting with an expandable external device. Accordingly, users can expand necessary peripheral interface depending on actual demands. In particular, since the PCI interface, which is a general and standard interface in a PC, is used for expanding in this embodiment, the action of expanding desired external device can be exactly carried out depending on user's demands. Accordingly, the main board 5 can be installed to obtain the previously mentioned expandable optical disk recording and playing system 4.

In summary, since the PCI interface is used to expanding external devices in the invention, the expandable optical disk recording and playing system and main board of the invention can provide an expanding interface module for expanding external devices depending on actual demands. Therefore, when manufacturing the optical disk recording and playing system, it is unnecessary to preinstall the peripheral interface. Moreover, users can expand the required peripheral interface depending on actual demands. As a result, the cost for the redundant peripheral interfaces can be saved. Furthermore, it is very convenient for the user to properly expand any required peripheral interface.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An expandable optical disk recording and playing system, comprising:
an input interface module;
a PCI expanding interface module, which comprises a PCI bus and an expanding component for connecting to an expanding interface, the expanding interface connecting to an expandable external device;
a storage interface module, which is used to connect to a storage device;
an output interface module; and
a CODEC module, which encodes, decodes or transcodes an audio/video source to generate audio/video data, wherein the audio/video data are outputted through the output interface module, through the PCI expanding interface module to the external device, and through the storage interface module to the storage device.

2. The system of claim 1, further comprising a microprocessor and a memory module, wherein the microprocessor and the memory module are respectively cooperating with the CODEC module to encode, decode or transcode the audio/video source.

3. The system of claim 1, wherein the input interface module receives the audio/video source via an antenna or a video cassette recorder (VCR).

4. The system of claim 1, wherein the expanding interface is an USB interface.

5. The system of claim 1, wherein the expanding interface is an IEEE 1394 interface.

6. The system of claim 1, wherein the expanding interface is a network interface.

7. The system of claim 1, wherein the external device is a memory card, a digital camera, a handy driver, a digital video, and a network attached storage (NAS).

8. The system of claim 1, wherein the storage device is a hard disk driver.

9. The system of claim 1, wherein the storage device is an optical disk driver, and the storage interface module is an ATA interface.

10. The system of claim 1, wherein the audio/video data are outputted through the output interface module to a monitor and a speaker.

11. A main board of an expandable optical disk recording and playing system, comprising:
a PCI bus;
at least one expanding component, which connects to one end of the PCI bus and is for connecting to an expanding interface, wherein the expanding interface connects to an expandable external device, and the PCI bus is for connecting the expanding component and internal devices of the expandable optical disk recording and playing system; and
a processing chip, which comprises an input interface module, a storage interface module, an output interface module, and a CODEC module, wherein the CODEC module encodes, decodes or transcodes an audio/video source to generate audio/video data, the audio/video source is inputted from the input interface module, from the PCI bus and the expanding component, and from the storage interface module, and the audio/video data are outputted through the output interface module, through the expanding interface to the external device, and through the storage interface module to a storage device.

12. The main board of claim 11, further comprises a microprocessor and a memory module, wherein the microprocessor and the memory module are respectively cooperating with the processing chip to encode, decode or transcode the audio/video source.

13. The main board of claim 11, wherein the input interface module receives the audio/video source via an antenna or a video cassette recorder (VCR).

14. The main board of claim 11, wherein the expanding interface is an USB interface.

15. The main board of claim 11, wherein the expanding interface is an IEEE 1394 interface.

16. The main board of claim 11, wherein the expanding interface is a network interface.

17. The main board of claim 11, wherein the external device is a memory card, a digital camera, a handy driver, a digital video, and a network attached storage (NAS).

18. The main board of claim 11, wherein the storage device is a hard disk driver.

19. The main board of claim 11, wherein the storage device is an optical disk driver, and the storage interface module is an ATA interface.

20. The main board of claim 11, wherein the audio/video data are outputted through the output interface module to a monitor and a speaker.

21. The main board of claim 11, wherein the expanding component is a slot.
